(19) United States
(12) Patent Application Publication
(10) Pub. No.: US 2023/0098840 A1
(43) Pub. Date: Mar. 30, 2023

(54) MEASUREMENT CONFIGURATION FOR NON-PUBLIC RADIO CELL

(71) Applicant: Lenovo (Singapore) Pte. Ltd., New Tech Park (SG)

(72) Inventors: Hyung-Nam Choi, Ottobrunn (DE); Genadi Velev, Darmstadt (DE); Joachim Loehr, Wiesbaden (DE); Prateek Basu Mallick, Dreieich (DE)

(21) Appl. No.: 17/904,278

(22) PCT Filed: Feb. 13, 2021
(86) PCT No.: PCT/IB2021/051221

§ 371 Date: Aug. 15, 2022

Related U.S. Application Data
(60) Provisional application No. 62/976,162, filed on Feb. 13, 2020.

(51) Int. Cl. H04W 36/00; H04W 48/02

(52) U.S. Cl. CPC H04W 36/0058; H04W 36/0085; H04W 48/02

(57) ABSTRACT

Apparatuses, methods, and systems are disclosed for configuring measurement reporting in non-public networks. One apparatus includes a transceiver that communicates with a UE , where the UE is connected to a non-public radio cell. The apparatus includes a processor that – via the transceiver - receives a first message containing a first indication of an access mode of the UE and sends a second message specifying at least one measurement configuration to the UE. The processor receives from the UEand via the transceiver – a measurement report containing measurement results of at least one neighboring radio cell of the communication network and determines to handover the UEto another radio cell of the communication network in accordance with the measurement results.

### CROSS-REFERENCE TO RELATED APPLICATIONS

This application claims priority to U.S. Provisional Pat. Application No. 62/906,576 entitled “CONFIGURATIONS FOR OPERATING DEVICES IN NON-PUBLIC NETWORKS” and filed on Feb. 13, 2020 for Hyung-Nam Choi, Genadi Velev, Joachim Loehr, and Prateek Basu Mallick, which application is incorporated herein by reference.

### FIELD

The subject matter disclosed herein relates generally to wireless communications and more particularly relates to configurations for operating devices in non-public networks.

### BACKGROUND

Private networks based on e.g., Femtocells (using e.g., 3rd Generation Partnership Project (“3GPP”) Long Term Evolution (“LTE”) closed subscriber group (“CSG”) concept and public networks) are deployed worldwide but overall is a small market. With LTE CSG, a limited set of users is granted connectivity/access to a femtocell, such that when the femtocell is configured in CSG mode, only those users included in the femtocell’s access control list are allowed to use the femtocell resources. In this sense, the private networks are deployed as Public Land Mobile Network (“PLMN”)-integrated network. Here, the femtocell is a small cell operated by a low-power cellular base station, typically designed for use in a home or small business environment. Private networks can be also deployed as complete LTE/EPC system in unlicensed frequency bands.

With Fifth Generation (“5G”), private networks attract attention to better fulfill the requirements from different industries and users in terms of high speed, low latency, and ultrareliable communication capabilities. The non-public network solutions are not limited to the support of Vertical and LAN Services, i.e., specific services used in particular industry or group of enterprises, but may also be applicable for a much wider range of use cases, such as Small Office/Home Office (“SOHO”), residential deployments, etc.

### BRIEF SUMMARY

Disclosed are procedures for configuring measurement reporting in non-public networks. Said procedures may be implemented by apparatus, systems, methods, or computer program products.

One method of a Radio Access Network (“RAN”) node includes receiving a first message containing a first indication of an access mode of a user equipment device (“UE”), where the UE is connected to a non-public radio cell, and transmitting a second message specifying at least one measurement configuration from the RAN node to the UE. The method includes receiving, from the UE, a measurement report containing the measurement results of at least one neighboring radio cell of the communication network and determining, by the RAN node, to handover the UE to another radio cell of the communication network in accordance with the measurement results.

One method of a UE includes a first message to a RAN node, the first message containing a first indication of an access mode of the UE and receiving a second message specifying at least one measurement configuration from the RAN node. The method includes performing measurement of at least one neighboring cell of the communication network in accordance with the at least one measurement configuration and transmitting measurement results to the RAN node. The method includes receiving a third message instructing the UE to handover to another radio cell of the communication network in accordance with the measurement results.

Another method of a UE includes receiving a first registration accept message containing mobility restriction information, the mobility restriction information permitting UE-initiated change of a non-public network (“NPN”) access mode. The method includes determining, by the UE, to trigger a change of the NPN access mode while operating in a first NPN access mode and sending a registration request message comprising a request to change the NPN access mode. The method includes receiving a second registration accept message containing a response to the request to change the NPN access mode.

One method of an access and mobility management function (“AMF”) includes sending a first registration accept message to a UE, the first registration accept message containing mobility restriction information permitting UE-initiated change of a NPN access mode. The method includes receiving a registration request message from the UE, the registration request message comprising a request to change the NPN access mode of the UE and sending a second registration accept message containing a response to the request to change the NPN access mode.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring measurement reporting in non-public networks;

FIG. 2 is a block diagram illustrating one embodiment of a 5G New Radio (“NR”) protocol stack;

FIG. 3 is a diagram illustrating one embodiment of a communication network with mixed deployment of public cells and Public Network Integrated NPN (“PNI-NPN”) cells;

FIG. 4 is a diagram illustrating one embodiment of message flow for UE configuration;

FIG. 5 is a diagram illustrating another embodiment of message flow for UE configuration;

FIG. 6 is a diagram illustrating another embodiment of a communication network with mixed deployment of public cells and Standalone NPN (“SNPN”) cells;

FIG. 7 is a diagram illustrating another embodiment of message flow for UE configuration;

FIG. 8 is a diagram illustrating one embodiment of message flow for UE registration;

FIG. 9 is a diagram illustrating one embodiment of message flow for UE deregistration;

FIG. 10 is a diagram illustrating one embodiment of a user equipment apparatus that may be used configuring a non-public network;

FIG. 11 is a diagram illustrating one embodiment of a network equipment apparatus that may be used configuring a non-public network;

FIG. 12 is a flowchart diagram illustrating one embodiment of a first method configuring a non-public network;

FIG. 13 is a flowchart diagram illustrating one embodiment of a second method configuring a non-public network;

FIG. 14 is a flowchart diagram illustrating one embodiment of a third method configuring a non-public network; and

FIG. 15 is a flowchart diagram illustrating one embodiment of a fourth method configuring a non-public network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, nontransitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an objectoriented programming language such as Python, Ruby, Java, Smalltalk, C++, or the like, and conventional procedural programming languages, such as the “C” programming language, or the like, and/or machine languages such as assembly languages. The code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus configuring a non-public network. According to the enhancements specified by 3GPP, 5G private networks (i.e., Non-Public Networks) may be deployed as a Public Network Integrated Non-Public Network (“PNI-NPN”), i.e., a network deployed for non-public use which relies on network functions provided by a PLMN. Alternatively, a 5G private network may be deployed as a Standalone Non-Public Network (“SNPN”), i.e., a network deployed for non-public use which does not rely on network functions provided by a PLMN.

For the case of a PNI-NPN, the NPN may be implemented with closed access group (“CAG”), i.e., realized by dedicated network slices for which additionally access control on RANlevel is carried out. The CAG identifies a group of subscribers who are permitted to access one or more CAG cells associated to the CAG. A CAG is identified by a CAG identifier (“ID”) broadcast in a System Information Block (“SIB”), such as SIB1, and the CAG ID is unique within the scope of a PLMN ID.

To implement a CAG, the UE subscription may contain the following parameters: 1) a list of subscribed Single Network Slice Selection Assistance Information (“S-NSSAI”), 2) an Allowed CAG list containing the CAG identifiers the UE is allowed to access, and 3) (optionally) a CAG-only indication if the UE is only allowed to access 5GS via CAG cells (this is to address e.g., factory devices that are supposed to remain on the CAG cells). A UE configured to only access CAG cells is not allowed to register via non-CAG cells of any PLMN. Additionally, access control for CAG may use a list of Tracking Area Identity (“TAI”) given by 5G Core Network (“5GC”) node (e.g., an AMF) on Non-Access Stratum (“NAS”) level as part of the registration procedure.

Alternatively, a PNI-NPN may be implemented without a CAG, i.e., realized by dedicated network slices for which no additional access control on RAN level is carried out. Here, the UE subscription contains a list of subscribed S-NSSAI but does not need the above CAGrelated parameters. Access control for PNI-NPN without CAG may use a list of TAI given by 5GC node (e.g., the AMF) on NAS level as part of the registration procedure.

For the case of a SNPN, the SNPN is identified by a PLMN ID and Network Identifier (“NID”) broadcast in SIB1. Here, the UE subscription contains the following parameters: 1) SNPN enabled UE; and 2) SNPN access mode. The parameter “SNPN enabled UE” refers to a UE configured to use Standalone Non-Public Networks (“SNPNs”). An SNPN-enabled UE is configured with subscriber identifiers and credentials for one or multiple SNPNs identified by the combination of PLMN ID and NID. The parameter “SNPN access mode” needs to be supported by an SNPN enabled UE.

When the UE is set to operate in SNPN access mode, the UE only selects and registers with SNPNs. If multiple SNPNs are available that the UE has subscriber identifier and credentials for, then the priority order for selecting and attempting to register with non-public networks is based on UE implementation. When the UE is not set to operate in SNPN access mode the UE performs normal PLMN selection procedures.

In various embodiments, RAN sharing may occur for NPNs according to the following scenarios. Scenario #1: NG-RAN is shared by multiple SNPNs (each identified by PLMN ID and NID); Scenario #2: NG-RAN is shared by one or multiple SNPNs and one or multiple PLMNs; Scenario #3: NG-RAN is shared by one or more PNI-NPNs (with CAG) and one or more SNPNs, and Scenario #4: NG-RAN is shared by one or multiple PLMNs and one or multiple PNI-NPNs (with CAG).

Here, “NG-RAN” (Next Generation RAN) refers to NR Radio Access Technology (“RAT”) connected to 5GC, and Evolved UMTS Terrestrial Radio Access (“E-UTRA”) RAT (aka LTE) connected to 5GC. PNI-NPNs (without CAG) are not explicitly listed above as it does not require additional NG-RAN sharing functionality compared to sharing by one or multiple PLMNs.

With regards to connected mode mobility support, the UE in RRC_CONNECTED state needs to be configured by network to measure/report neighboring cells in order to properly perform handover depending on, e.g., the mobility of the UE or network load (in source cell and candidate target cells, e.g., reported via Xn/X2 interface).

In certain embodiments, the configuration of measurement and reporting for NPN takes into account deployment scenarios ofNPN, i.e., Dedicated deployment, i.e., NPN and public cells are operated on different carrier frequencies; or Mixed deployment, i.e., NPN and public cells are operated on the same carrier frequency.

The configuration of measurement and reporting for NPN may also take into account RAN sharing scenarios due to the fact that the more core networks share the same RAN the higher the risk that RAN overload may occur, so that handovers or cell access restrictions need to be applied more frequently for load balancing and to avoid congestion. Additional factors considered for measurement and reporting configuration include: UE mobility and location, UE subscription for NPN, i.e., for PNI-NPN and/or SNPN, and special types of UE (non-NPN or NPN UEs, e.g., reduced capability UEs) for which cell access restrictions may need to be applied for load balancing or to avoid congestion.

In accordance with the measurement and reporting configuration by the network, the UE measures neighboring cells and reports the cells which fulfill the measurement criteria (e.g., measurement object, thresholds, periodical or event-based triggering, cells to measure, etc.). The UE receives the measurement and reporting configuration from the network either via the RRCReconfiguration or RRCResume messages. Such configuration (i.e., using the ‘measConfig’ Information Element (“IE”)) may indicate a measurement ID, an object to measure (e.g., to add to the list), and reporting conditions. As described in greater detail below, the configuration IE measConfig may be modified and/or expanded to support measurement and reporting for NPN.

With regards to operation of NPN-capable UEs in NPN and PLMN (i.e., cell selection/reselection, cell access control and connected mode mobility support etc.), to support CAG, the UE may be pre-configured or (re-)configured with the CAG information. This information is (re-)configured by the AMF using the generic UE Configuration Update procedure for access and mobility management related parameters, e.g., when CAG-IDs are added or removed, or CAG-only indication is changed during the registration procedure. In the AMF, the latest version of the CAG information is then stored as UE context as part of Mobility Restrictions information.

In Rel-16, the Allowed CAG list and CAG-only indication setting comes from the UE subscription information stored in UDM/UDR. The allowed CAG list and CAG-only indication are considered by the AMF when generating the Mobility restrictions information. The AMF provides the mobility restrictions to the UE and to the RAN to steer the UE to use CAG cells accordingly. In Rel-16, the CAG-only indication (here called CAG mode of operation) can only be changed by the UDM/UDR triggered modification.

In Rel-16, the UE can be configured to operate in SNPN access mode. The UE configured in SNPN access mode only selects cells and networks broadcasting both PLMN ID and NID of the selected SNPN. It is up to UE implementation (e.g., higher layer logic configuration or based on user input) how the UE can disable the SNPN access mode.

As discussed in further detail below, the UE may update the CAG information on its own (e.g., adding new CAG ID or changing the CAG-only indication configuration). Similarly, to support SNPN, an SNPN-enabled UE can be configured to operate in SNPN access mode and autonomously change the activation and deactivation of SNPN access mode at the SNPN-enabled UE. Described herein are parameters which may be configured by the network for reporting by the UE in the context of the measurement procedure to support all types of NPN mobility cases, i.e., inbound mobility (to an NPN cell) and outbound mobility (from an NPN cell).

Allowing an autonomous change (i.e., initiated by the UE) of CAG-only indication or SNPN access mode supports flexible change based on e.g., coverage situation. For example, if there is no SNPN cell or CAG cell coverage, then the user may reset temporarily the concerned flag to “No” to enable the UE to search for public cell coverage. As another example, a CAGcapable UE is registered in a public network at the airport and is in RRC_CONNECTED state in a public cell of the PLMN. The CAG-only indication is initially not configured in the CAG information. The human user is informed about an accessible CAG (of the same selected PLMN) in the Airport lounge. To access the CAG, the human user adds the concerned CAG-ID and configures the CAG-only indication in the CAG information.

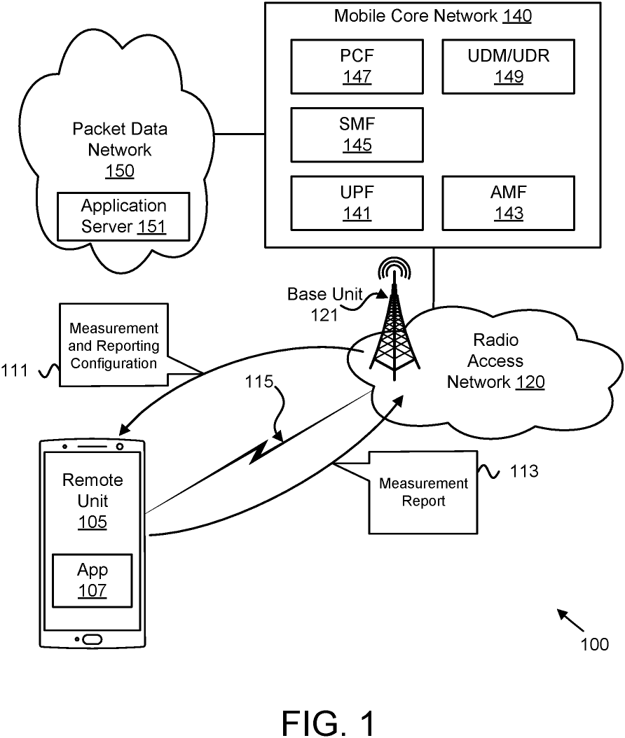

FIG. 1 depicts a wireless communication system 100 configuring a non-public network, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 140 are depicted in FIG. 1, one of skill in the art will recognize that any number of remote units 105, base units 121, wireless communication links 115, RANs 120, and mobile core networks 140 may be included in the wireless communication system 100.

In one implementation, the RAN 120 is compliant with the 5G system specified in the 3GPP specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140. As described in greater detail below, the RAN 120 may send a measurement and reporting configuration 111 to the remote unit 105, wherein the remote unit 105 sends a measurement report 113 to the RAN 120.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”)141.

In order to establish the PDU session (or PDN connection), the remote unit 105 must be registered with the mobile core network 140 (also referred to as “attached to the mobile core network” in the context of a Fourth Generation (“4G”)system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 115. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. Each mobile core network 140 belongs to a single PLMN. The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, and a Unified Data Management function (“UDM”). In some embodiments, the UDM is co-located with a User Data Repository (“UDR”), depicted as combined entity “UDM/UDR” 149. In various embodiments, the mobile core network 140 may also include an Authentication Server Function (“AUSF”), a Network Repository Function (“NRF”) (used by the various NFs to discover and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a single-network slice selection assistance information (“S-NSSAI”), while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

While FIG. 1 depicts components of a 5G RAN and a 5G core network, the described embodiments for configuring measurement reporting in non-public networks apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

In the following descriptions, the term “RAN node” is used for the base station but it is replaceable by any other radio access node, e.g., gNB, eNB, Base Station (“BS”), Access Point (“AP”), etc. Further, the operations are described mainly in the context of 5G NR. However, the proposed solutions/methods are also equally applicable to other mobile communication systems supporting measurement reporting in non-public networks.

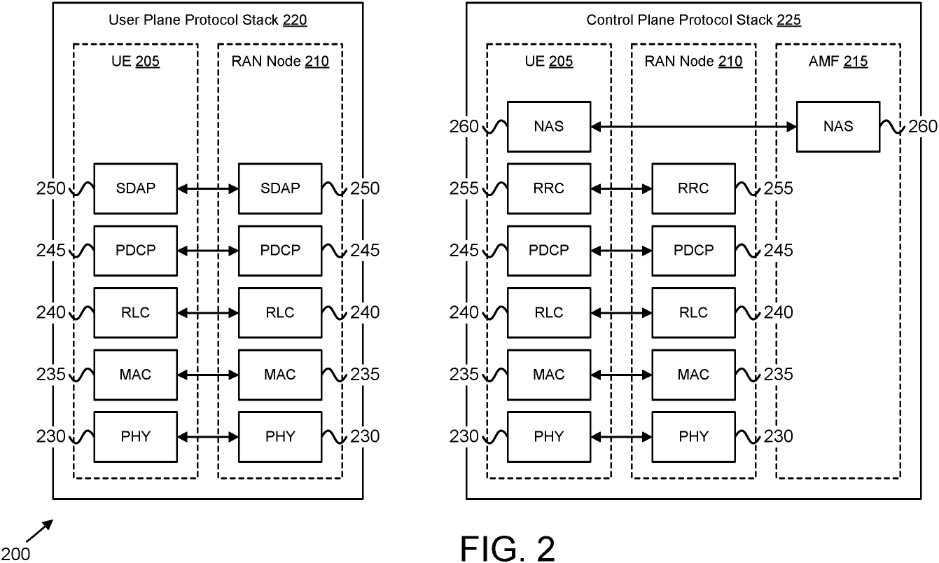

FIG. 2 depicts a NR protocol stack 200, according to embodiments of the disclosure. While FIG. 2 shows a UE 205, a RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 220 and a Control Plane protocol stack 225. The User Plane protocol stack 220 includes a physical (“PHY”) layer 230, a Medium Access Control (“MAC”) sublayer 235, the Radio Link Control (“RLC”) sublayer 240, a Packet Data Convergence Protocol (“PDCP”) sublayer 245, and Service Data Adaptation Protocol (“SDAP”) layer 250. The Control Plane protocol stack 225 includes a physical layer 230, a MAC sublayer 235, a RLC sublayer 240, and a PDCP sublayer 245. The Control Plane protocol stack 225 also includes a Radio Resource Control (“RRC”) layer 255 and a Non-Access Stratum (“NAS”) layer 260.

The AS layer (also referred to as “AS protocol stack”) for the User Plane protocol stack 220 consists of at least SDAP, PDCP, RLC and MAC sublayers, and the physical layer. The AS layer for the Control Plane protocol stack 225 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 255 and the NAS layer 260 for the control plane and includes, e.g., an Internet Protocol (“IP”) layer or PDU Layer (not depicted) for the user plane. L1 and L2 are referred to as “lower layers,” while L3 and above (e.g., transport layer, application layer) are referred to as “higher layers” or “upper layers.”

The physical layer 230 offers transport channels to the MAC sublayer 235. The MAC sublayer 235 offers logical channels to the RLC sublayer 240. The RLC sublayer 240 offers RLC channels to the PDCP sublayer 245. The PDCP sublayer 245 offers radio bearers to the SDAP sublayer 250 and/or RRC layer 255. The SDAP sublayer 250 offers QoS flows to the core network (e.g., 5GC). The RRC layer 255 provides for the addition, modification, and release of Carrier Aggregation and/or Dual Connectivity. The RRC layer 255 also manages the establishment, configuration, maintenance, and release of Signaling Radio Bearers (“SRBs”) and Data Radio Bearers (“DRBs”). The NAS layer 260 is used to convey non-radio signaling between the UE 205 and, e.g., an AMF 215 in the 5GC (or a MME for an LTE/EPS scenario).

To improve operation of NPN-capable UEs in NPN and PLMN, and in dedicated and mixed deployment scenarios the following solutions are proposed:

To support autonomous (i.e., UE-initiated) setting of CAG information (including Allowed CAG list and “CAG-only indication”) and/or “SNPN access mode” by the UE 205, a core network node (e.g., AMF 215) can control whether a UE-initiated change of configuration for CAG information or SNPN access mode is allowed or not.

For CAG, new parameters (“UE allowed to change CAG-ID,” “UE allowed to change CAG mode”) in Mobility restrictions information at the AMF 215 is defined specifying whether or not Allowed CAG list and CAG-only indication can be changed autonomously by the UE 205. If autonomous configuration change is not allowed, then the UE 205 needs to send a request to the AMF 215 for changing the concerned CAG information.

For SNPN, a new parameter (“UE allowed to change SNPN access mode”) in the UE context at the AMF 215 is defined specifying whether SNPN access mode can be changed autonomously by the UE or not. If it is not allowed, then the UE needs to send a request to AMF for changing the SNPN access mode. Upon reception of each request from the UE, the AMF can accept or reject the concerned request.

If autonomous change of CAG-only indication or SNPN access mode by the UE is allowed, new information about the NPN access mode indication is provided to the network indicating whether the UE is operating in SNPN access mode or in CAG-only mode. This indication can be sent to the network in various ways as described herewith.

According to a first option, this indication is sent by the UE to the RAN node (NPN or PLMN) on AS level. Candidate RRC messages include: the RRCSetupComplete message, the RRCResumeComplete message, the RRCReconfigurationComplete message, the RRCReestablishmentComplete message, the MeasurementReport message, and the UEAssistanceInformation message.

Beside the above existing RRC messages, the mode change indication can be also added in any appropriate RRC messages which will be newly introduced in Rel-16, e.g., as part of the power saving functionality, etc. The received “NPN mode change indication” can be used by the RAN node for configuring measurements and cell selection/reselection parameters, performing handover and redirection or for admission control.

According to a second option, the indication is sent by 5GC (e.g., AMF) to RAN node (NPN or PLMN) on N2 interface using NG-AP or S1 interface using S1-AP signaling exchange. Candidate NG-AP or S1-AP messages include: the Initial Context Setup Request message, and the UE Radio Capability Check Request message.

According to a third option, the indication is sent by UE to 5GC (e.g., AMF) on NAS level. Candidate NAS messages include: the Deregistration Request message, and the UL NAS Transport message. The received “NPN mode change indication” can be used by 5GC for de-registering the UE or to update the UE context stored at 5GC.

In case an RRC connection release is needed due to change of CAG information or SNPN access mode by the UE, the UE in RRC_CONNECTED or RRC_INACTIVE sends an RRC connection release request to the RAN node by setting a new cause value (e.g., “NPN access mode change”). This new cause value may be sent e.g., in the existing RRC UEAssistanceInformation message. But other existing UL RRC messages may be applicable as well. Furthermore, the new cause value may be also sent in any appropriate RRC messages which will be newly introduced in Rel-16, e.g., as part of the power saving functionality etc. With the received cause value, the RAN node can initiate the release of the RRC connection.

To support Cell access restrictions for special types of UEs, new UE types are introduced with which the NPN/non-NPN RAN node can apply further cell access restrictions. The new UE types are signaled as part of UE capability information signaling, either from the UE to the NPN RAN node or from the 5GC to the NPN RAN node. Candidate types can be defined in a modem-centric and/or service-centric manner:
Type 1: UEs requiring reduced bandwidth operation, e.g., lower than 5 MHz in FR1 (i.e., Frequency Range Between 410 MHz to 7.125 GHz) and lower than 50 MHz in FR2 (i.e., Frequency Range Between 24.25 GHz to 52.6 GHz).
Type2: UEs requiring the use of enhanced coverage functionalities, e.g., extended repetition levels for the transmission of physical channel due to support of one receive (“RX”) antenna.
Type3: Power-limited UEs requiring UE power saving optimizations.
Type4: UEs requiring voice services.
Type5: UEs requiring delay-tolerant services.

If cell access restrictions need to be applied, the NPN/non-NPN RAN node broadcasts the access restrictions per UE type in SIB.

To address the parameters which need to be configured by network (and to be reported by UE) in the context of the measurement procedure to support all types of NPN mobility cases, new parameters are introduced in measurement and reporting configuration. In detail:
In IE MeasObjectNR:
   Type of cells to measure: (e.g., one of [public and private with SNPN]; [public and private with CAG]; [public only]; [private with SNPN and CAG], [private with SNPN]; or [private with CAG])
In IE ReportConfigNR:
   Include PLMN-Identity list for SNPN and PNI-NPN
   Include Member status per SNPN and PNI-NPN cell
   Include CAG identities per PNI-NPN cell with CAG
   Include Cell access restrictions for new UE types
In IE MeasResultListNR:
   PLMN-Identity list for SNPN (combination of PLMN-ID and NID) and PNI-NPN
   Member status per SNPN and PNI-NPN cell, i.e., whether the cell is an SNPN member cell (a PLMN-ID and NID broadcast by the cell matches the selected SNPN by the UE) or CAG member cell (a CAG identifier broadcast by the cell is contained in the Allowed CAG list of the UE)
   CAG identities per PNI-NPN cell with CAG
   Cell access restrictions for new UE types

Based on the measurement and reporting configuration received from the NPN RAN node the UE performs the measurement and reports the measured results in a measurement report to the NPN RAN node. And in accordance with the received measurement report the NPN network performs the handover of that UE to an appropriate candidate target cell.

The proposed solutions allow to improve operation of NPN-capable UEs in NPN and PLMN in all RRC states with regards to cell selection/reselection, cell access control and connected mode mobility support etc. For instance, the following types of mobility can be supported:
For PNI-NPN with CAG:
   Inbound (from non-CAG/CAG cell to CAG cell) and outbound mobility (from CAG cell to non-CAG/CAG cell) depending on the allowed S-NSSAIs and CAG information configuration in the UE (PLMN-Id, Allowed CAG list, CAG-only indication)
For PNI-NPN w/o CAG:
   Inbound (from non-PNI-NPN/PNI-NPN cell w/o CAG to PNI-NPN cell w/o CAG) and outbound mobility (from PNI-NPN cell w/o CAG to non-PNI-NPN/PNI-NPN cell w/o CAG) depending on the allowed S-NSSAIs
For SNPN:
   Mobility within an SNPN (in case there is no Xn nor NG handover supported between SNPNs)
   Inbound and outbound mobility between SNPNs (in case Xn or NG handover is supported between SNPNs)

Although the proposed solution and the described embodiments focus on NR RAT connected to 5GC, they are principally applicable to E-UTRA RAT connected to 5GC as well.

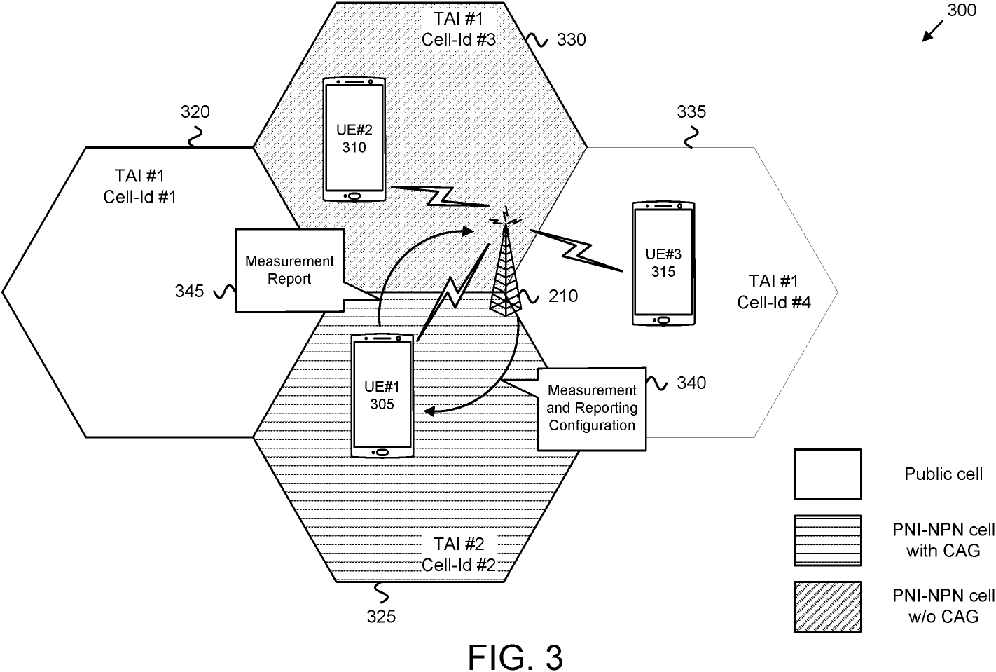

FIG. 3 depicts a communication network 300 with mixed deployment of public cells and PNI-NPN cells operating on the same carrier frequency, according to embodiments of the disclosure. According to a first solution, the network supports connected mode mobility from PNI-NPN cell with CAG to public cell via RRC layer. The network 300 includes a RAN comprising several cells, including a first cell 320 (having Cell-ID #1), a second cell 325 (having Cell-ID #2), a third cell 330 (having Cell-ID #3), and a fourth cell 335 (having Cell-ID #4). As depicted, the network 300 includes a RAN node 210 and at least three UEs, including a first UE (i.e., UE#1) 305, a second UE (i.e., UE#2) 310, and a third UE (i.e., UE#3) 315. Here, the UEs 305, 310 and 315 may be embodiments of the remote unit 105 and/or UE 205, described above. Furthermore, the cell configurations as shown in Table 1 are assumed.

TABLE 1

Exemplary cell configurations

| Cell-Id | Broadcast information per SIB | Network type |
|---|---|---|
| #1 | PLMN-Id #1; TAI #1 | Public; no RAN sharing |
| #2 | PLMN-Id #1; TAI #2 CAG-ID = [1, 3, 4, 6] | PNI-NPN with CAG; no RAN sharing |
| #3 | PLMN-Id #1; TAI #1 Cell access restrictions = [Type1, Type2; Type3] | PNI-NPN w/o CAG; no RAN sharing |
| #4 | PLMN-Id #1; TAI #1 | Public; no RAN sharing |

Additionally, for the UE#1 305, it is assumed that the UE#1 305 is registered in the PLMN (e.g., with PLMN-Id#1) that supports both public and private cells. It is assumed that the Allowed CAG list in the subscription of UE#1 305 contains the CAG-IDs = [1, 2, 3]. Here, the CAG-only indication is not set, i.e., the UE#1 is allowed to access 5GS via CAG cells and public cells.

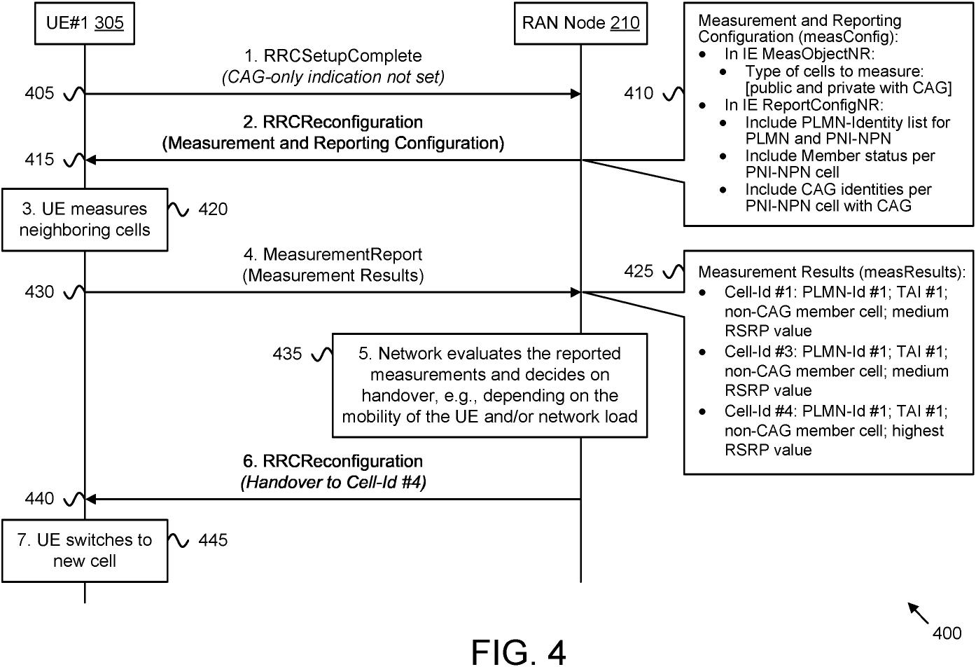

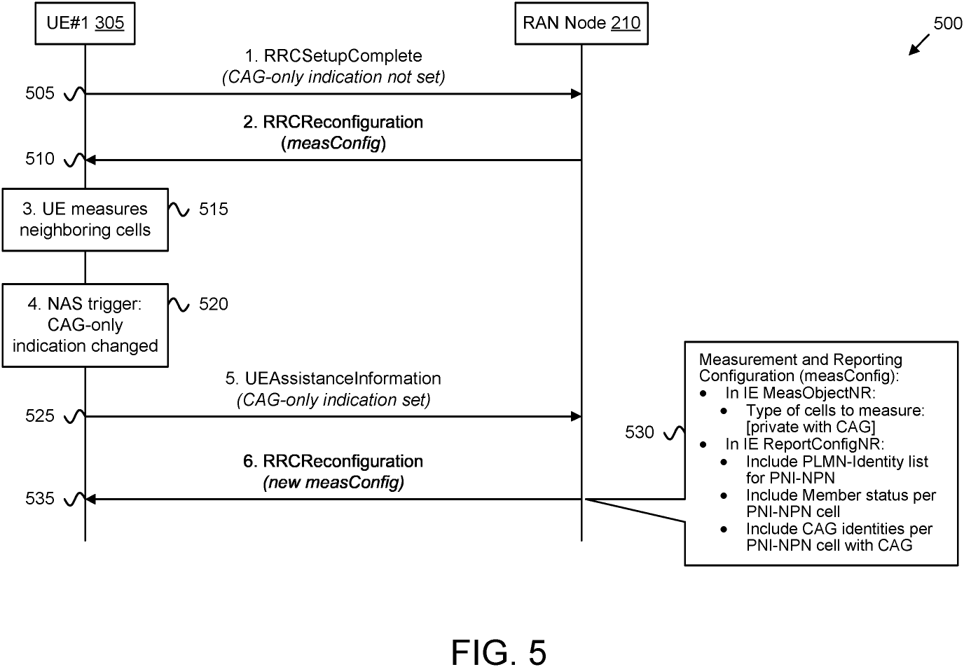

In various embodiments, the UE#1 305 receives a measurement and reporting configuration 340 from the RAN node 210. The UE#1 305 performs measurements according to the configuration and sends a measurement report 345 to the RAN node 210. Details of the configuration and reporting are described below with reference to FIGS. 4-5. Note that the UE#2 310 and/or UE#3 315 may also receive measurement and reporting configurations from the RAN node 210. According to the specific configurations, the UE#2 310 and UE#3 315 would send measurement reports to the RAN node 210.

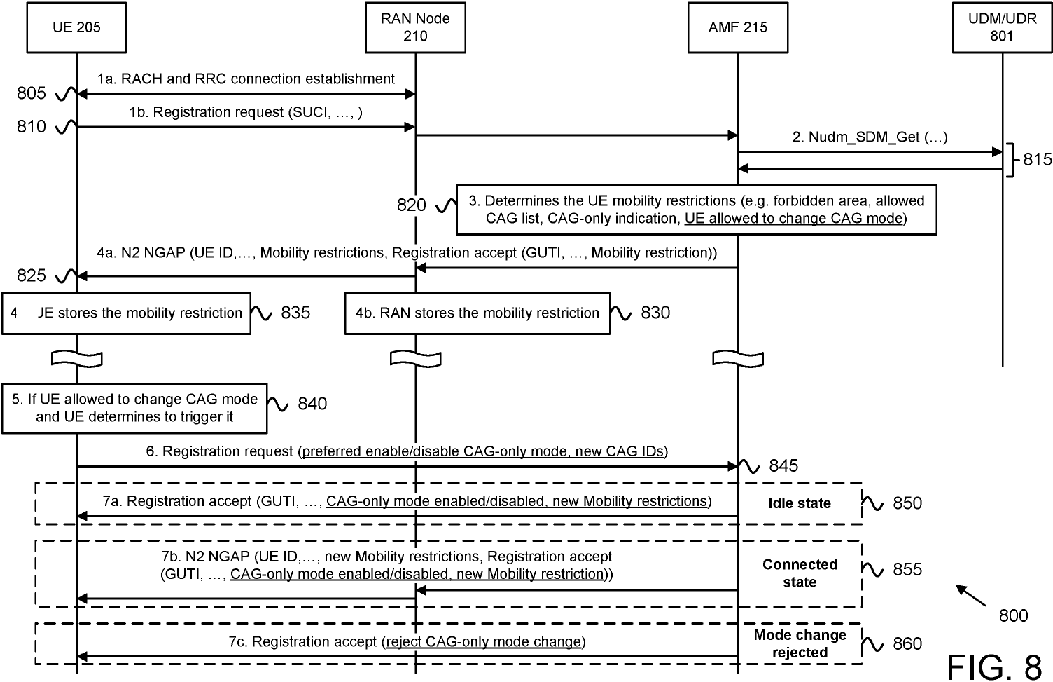

As result of a registration procedure, it is assumed that the UE#1 305 has been allowed by the AMF (i.e., AMF 143) to autonomously change the configuration of its CAG information. It is also assumed that the UE#1 305 is in connected mode in the CAG member cell with Cell-Id#2 and based on CAG-ID#1, and that the UE#1 is a normal UE, i.e., none of the special UE types apply. Details of UE-initiated CAG access mode change are described below with reference to FIG. 8.

FIG. 4 shows an exemplary message flow of a procedure 400 for the handover of a UE, according to the first solution. The procedure 400 involves the UE#1 305 and a RAN node 210. Here, it is assumed the UE#1 305 is in operating in the communication network 300.

At Step 1, the UE#1 305 sends to the RAN node 210 a RRCSetupComplete message which includes the information that CAG-only indication is not set for the UE#1 305 (see messaging 405).

At Step 2, the RAN node 210 sends to the UE#1 305 a measurement and reporting configuration 410 via a RRCReconfiguration message (see messaging 415). In some embodiments, the UE#1 305 sends a RRCReconfigurationComplete message as response to the successful reception of the RRCReconfiguration message (not shown in FIG. 4).

In the depicted embodiment, the UE#1 305 receives, inter alia, the following measurement and reporting configuration 410: In IE MeasObjectNR, the UE#1 305 receives the type of cells to measure as: [public and private with CAG]. In IE ReportConfigNR, the UE#1 305 receives: Include PLMN-Identity list for PLMN and PNI-NPN, Include Member status per PNI-NPN cell, and Include CAG identities per PNI-NPN cell with CAG.

At Step 3, based on the measurement and reporting configuration received from the RAN node 210 the UE#1 305 performs the measurement (see block 420).

At Step 4, the UE#1 305 reports the measured results 425 to the RAN node 210 via MeasurementReport message (see messaging 430). Here, the measured results 425 include, e.g., the following information: [Cell-Id #1: PLMN-Id #1; TAI #1; non-CAG member cell; medium RSRP value], [Cell-Id #3: PLMN-Id #1; TAI #1; non-CAG member cell; medium RSRP value], and [Cell-Id #4: PLMN-Id #1; TAI #1; non-CAG member cell; highest RSRP value].

At Step 5, the RAN node 210 evaluates the reported measurements and decides on handover, e.g., to the public cell 335 with Cell-Id #4, considering the fact that it is the strongest cell (based on the above example measured results) and the UE#1 305 is allowed to access 5GS via public cells (see block 435).

At Step 6, the handover decision is sent to the UE#1 305 via RRCReconfiguration message, e.g., including all information required for the UE 205 to access the target cell 335 (see messaging 440).

At Step 7, the UE 205 switches to the public cell 335 with Cell-Id #4 (see block 445).

FIG. 5 shows an exemplary message flow of a procedure 500, according to a second solution of the disclosure. The second solution relates to change of CAG-only indication during ongoing measurement process via RRC layer.

The procedure 400 involves the UE#1 305 and a RAN node 210. Here, it is assumed the UE#1 305 is in operating in the communication network 300.

At Step 1, the UE#1 305 sends to the RAN node 210 a RRCSetupComplete message which includes the information that CAG-only indication is not set for the UE#1 305 (see messaging 505).

At Step 2, the RAN node 210 sends to the UE#1 305 a measurement and reporting configuration via a RRCReconfiguration message (see messaging 510). Here, it is assumed that the UE#1 305 receives the same measurement and reporting configuration 410 described above with reference to FIG. 4.

At Step 3, based on the measurement and reporting configuration received from the RAN node 210 the UE#1 305 performs the measurement (see block 515).

At Step 4, during ongoing measurement process the UE#1 305 receives, e.g., from the NAS layer, a trigger that the CAG-only indication changed from “not set” to “set” (see block 520). In some embodiments, the CAG-only indication change is due to setting from the human user.

At Step 5, information of the CAG-only indication change is sent by the UE#1 305 to the RAN node 210 via UEAssistanceInformation message (see messaging 525).

At Step 6: As response the RAN node 210 sends to the UE#1 305 a new measurement and reporting configuration 530 via RRCReconfiguration message (see messaging 535). In the depicted embodiment, the UE#1 305 receives, inter alia, the following measurement and reporting configuration 530: In IE MeasObjectNR, the UE#1 305 receives the type of cells to measure as: [private with CAG]. In IE ReportConfigNR, the UE#1 305 receives: Include PLMN-Identity list for PNI-NPN; Include Member status per PNI-NPN cell; and Include CAG identities per PNI-NPN cell with CAG.

Based on the new measurement and reporting configuration received from the RAN node 210 the UE#1 305 restarts measuring neighboring cells, but due to the fact that no neighboring CAG cells are available, the UE#1 305 will not send any measurement results to the RAN node 210. As consequence, the RAN node 210 will not be able to handover the UE#1 305 to another CAG cell if the UE#1 305 leaves the coverage of Cell-Id #2.

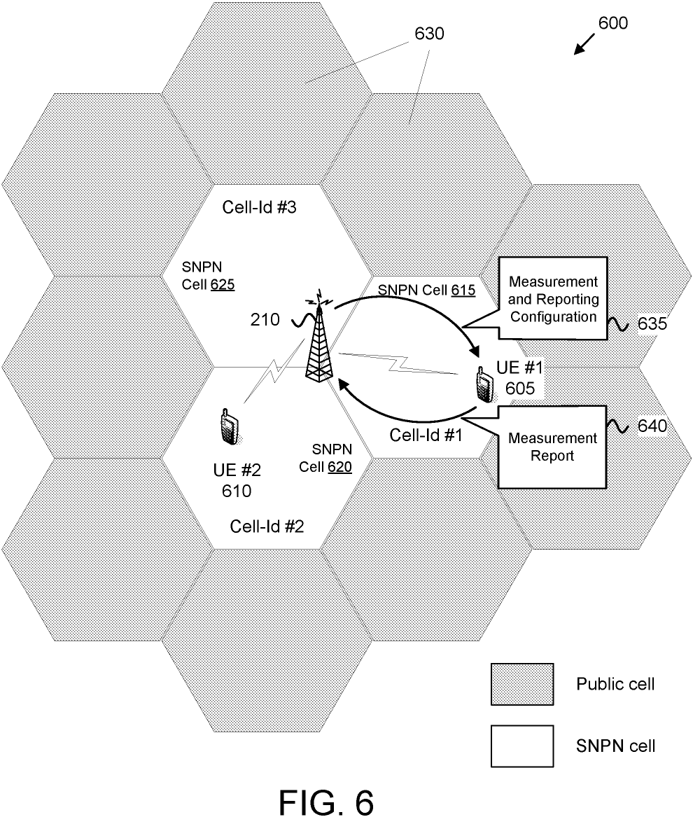

FIG. 6 depicts a communication network 600 with mixed deployment of public cells and SNPN cells operating on the same carrier frequency, according to embodiments of the disclosure. As depicted, coverage area of SNPN cells is much smaller compared to public cells 630. According to a third solution, the network supports UE connected mode mobility within SNPN via RRC layer. The network 600 includes a RAN comprising several cells, including a first SNPN cell 615 (having Cell-ID #1), a second SNPN cell 620 (having Cell-ID #2), and a third SNPN cell 625 (having Cell-ID #3). As depicted, the network 600 includes a RAN node 210 and at least two UEs, including a first UE (i.e., UE#1) 605 and a second UE (i.e., UE#2) 610. Here, the UEs 605 and 610 may be embodiments of the remote unit 105 and/or UE 205, described above.

In the depicted example, it is assumed that the UE#1 605 is registered in the SNPN (identified by PLMN-Id + NID); here, the UE#1 605 is an SNPN enabled UE. It is assumed that the SNPN access mode is set, i.e., the UE#1 605 is allowed to access 5GS via SNPN cells only.

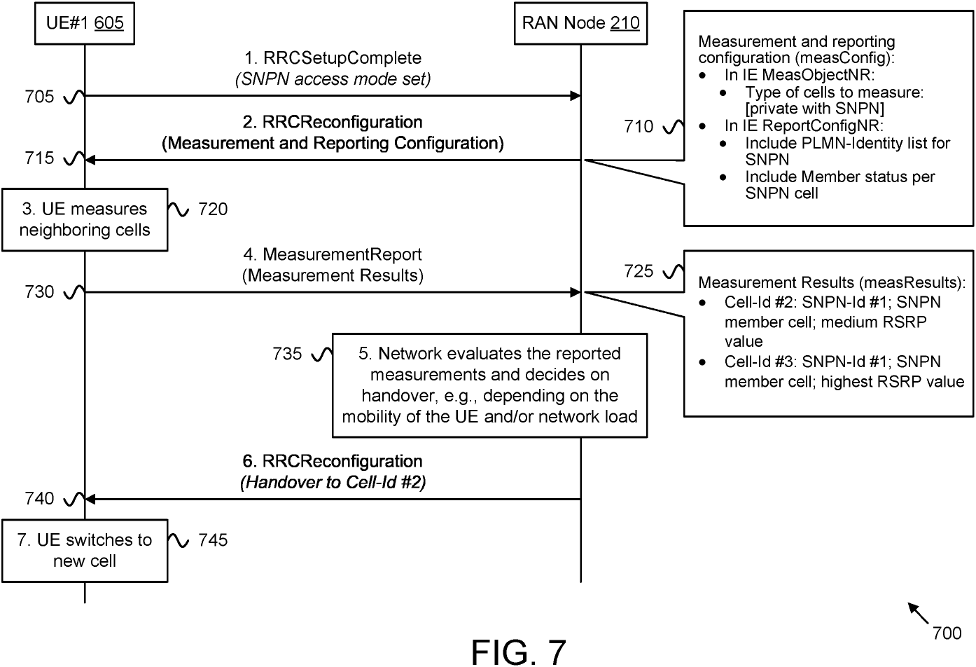

In various embodiments, the UE#1 605 receives a measurement and reporting configuration 635 from the RAN node 210. The UE#1 605 performs measurements according to the configuration and sends a measurement report 640 to the RAN node 210. Details of the configuration and reporting are described below with reference to FIG. 7. Note that the UE#2 610 may also receive measurement and reporting configurations from the RAN node 210. According to the specific configurations, the UE#2 610 would send measurement reports to the RAN node 210.

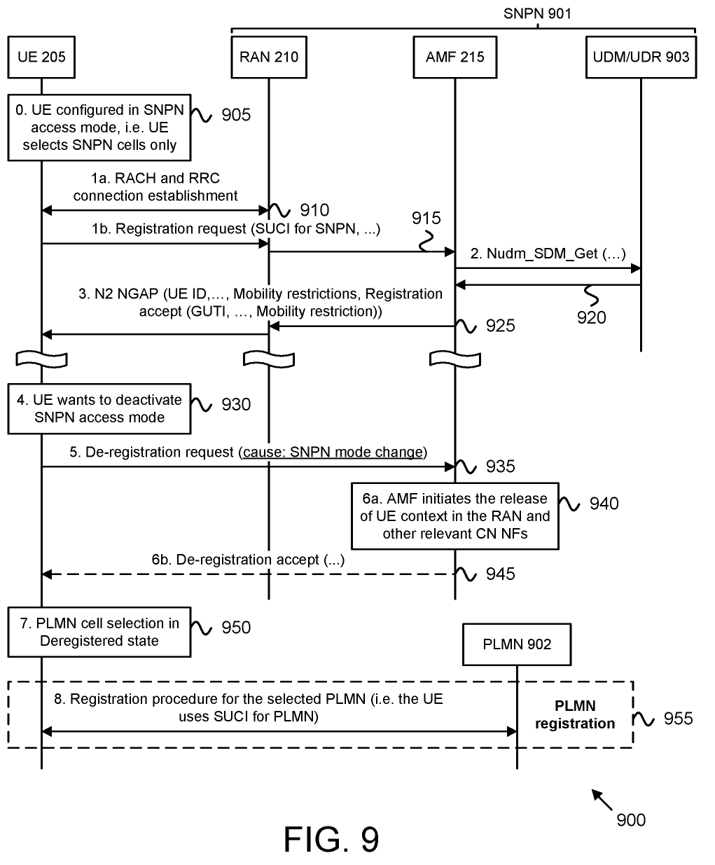

As result of the registration procedure the UE#1 605 has been allowed by the AMF to autonomously change the configuration of the SNPN access mode. It is assumed that the UE#1 605 is in connected mode in the first SNPN member cell 615 with Cell-Id #1 and that the UE#1 is a normal UE, i.e., none of the special UE types apply. Details of the UE-initiated SNPN access mode change are described below with reference to FIG. 9.

FIG. 7 shows an exemplary message flow of a procedure 700 for the handover of a UE, according to the third solution. The procedure 700 involves the UE#1 605 and a RAN node 210. Here, it is assumed the UE#1 605 is in operating in the communication network 600.

At Step 1, the UE#1 605 sends to the RAN node 210 via RRCSetupComplete message the information that SNPN access mode is set (see messaging 705).

At Step 2, the RAN node 210 sends to the UE#1 605 a measurement and reporting configuration 710 via RRCReconfiguration message (see messaging 715). In some embodiments, the UE#1 605 may send a RRCReconfigurationComplete message as response to the successful reception of the RRCReconfiguration message (not shown in FIG. 7).

In the depicted embodiment, the UE#1 605 receives, inter alia, the following measurement and reporting configuration 710: In IE MeasObjectNR, the UE#1 605 receives the type of cells to measure as: [private with SNPN]. In IE ReportConfigNR, the UE#1 605 receives: Include PLMN-Identity list for SNPN; and Include Member status per SNPN cell.

At Step 3, based on the measurement and reporting configuration received from the RAN node 210 the UE#1 605 performs the measurement (see block 720).

At Step 4, the UE#1 605 reports the measured results 725 to the RAN node 210 via MeasurementReport message (see messaging 730). In the depicted embodiment, the measurement results 725 include the following information: [Cell-Id #2: SNPN-Id #1; SNPN member cell; medium RSRP value]; and [Cell-Id #3: SNPN-Id #1; SNPN member cell; highest RSRP value].

At Step 5, the RAN node 210 evaluates the reported measurements and decides on handover to the SNPN cell 620 with Cell-Id #2, e.g., considering the fact that it is the strongest cell and the UE#1 605 is allowed to access the 5GS via SNPN cells only (see block 735).

At Step 6, the handover decision is sent to the UE#1 605 via a RRCReconfiguration message (see messaging 740). Here, the RRCReconfiguration message includes all information required for the UE#1 605 to access the target cell 620.

At Step 7, the UE#1 605 switches to the SNPN cell 620 having Cell-Id #2 (see block 745).

According to a fourth solution, in order to allow the UE 205 to request change of CAG mode of operation, a new parameter is introduced in the UE subscription information (e.g., in UDM/UDR 149) whether the CAG mode of operation can be overwritten. This new parameter is provided to the AMF 215 and to the UE 205. If this new parameter is set to ‘yes’, then the UE 205 may initiate a procedure for changing of the CAG mode of operation, by using e.g., the NAS registration procedure.

The UE 205 includes in the Registration Request message a new indication for disabling the CAG only mode (e.g., ‘disable CAG only mode’). It is for the AMF 215 to decide whether the request for CAG-only mode change from the UE 205 is accepted or not. The AMF 215 signals the result to the UE 205 in the Registration Accept message either 1) using an explicit indication, or 2) implicitly in the Mobility restrictions information. As discussed above, allowing an autonomous change (i.e., initiated by the UE 205) of CAG-only indication or SNPN access mode supports flexible change based on e.g., coverage situation.

FIG. 8 depicts an exemplary message flow for a procedure 800 for UE-requested CAG mode change via NAS layer, according to the fourth solution. The procedure 800 involves the UE 205, the RAN node 210, the AMF 215, and a UDM/LTDR 801. Here, the UE 205 may be one embodiment of the remote unit 105, the RAN node 210 may be one embodiment of the base unit 121, the AMF 215 may be one embodiment of the AMF 143, and the UDM/UDR 801 may be one embodiment of the UDM/UDR 149. The description of FIG. 8 is as follows:

At step 1, the UE 205 performs a registration procedure in order to obtain service from the network (e.g., home PLMN). For this purpose, the UE 205 performs RACH procedure and RRC connection establishment (Step 1a; see messaging 805) in order to transmit the NAS Registration Request message (Step 1b; see messaging 810).

At step 2, if the AMF 215 does not have the current UE subscription, the AMF 215 retrieves the UE subscription data from the UDM 801 (see messaging 815).

At step 3, the AMF 215 determines the UE mobility restrictions (e.g., forbidden area, allowed CAG list, CAG-only indication, UE allowed to change CAG mode) (see block 820). A new parameter “UE allowed to change CAG mode” is introduced to allow the UE 205 to update the CAG-only mode of operation. For example, the NPN customer (e.g., 3rd party customer) can set via SLA whether the CAG-only mode of operation can be overwritten by the UE 205.

At step 4a, the AMF 215 sends the mobility restriction information to the UE 205 (via NAS registration accept message) and to the RAN node 210 (via N2 NGAP message) (see messaging 825). At step 4b, the RAN node 210 stores the mobility restriction (see block 830). At step 4c, the UE 205 stores the mobility restriction (see block 835).

At step 5, at some later time, based on the indication that the UE 205 is allowed to change CAG-only mode, the UE 205 determines to trigger UE-initiated CAG-only mode change (see block 840). Optionally, the UE 205 may determine to request a new CAG ID to be included in the existing list of Allowed CAG IDs.

At step 6, the UE 205 sends Registration Request message including one or more new parameters to indicate the request for CAG-only mode change (e.g., ‘preference to enable/disable CAG-only mode’), new CAG IDs (see messaging 845).

At step 7, the network (e.g., AMF 215 or other NF) can decide whether to accept or reject the UE’s request in step 6. The network (e.g., AMF 215) may indicate the decision using one of the following options:

At Step 7a, if the UE 205 is in CM-Idle state (e.g., there is no UE context in the RAN node 210), then the AMF 215 sends a Registration Accept message to the UE 205 indicating that the UE request is accepted (see messaging 850).

At Step 7b, if the UE 205 is in CM-Connected state (e.g., there is UE context in the RAN node 210), then the AMF 215 sends Registration Accept indicating that the UE request is accepted and new/updated mobility restrictions, and the AMF 215 also updates the UE context in the RAN node 210 with the new mobility restrictions (see messaging 855).

At Step 7c, the AMF 215 may reject the UE request (see messaging 860). Here, the AMF 215 may send a Registration Accept message to the UE 205 indicating that the UE request is rejected.

It should be noted that FIG. 8 shows the non-roaming scenario, i.e., the UE is registered with the home PLMN. The described solutions are also applicable to roaming scenario where the UE 205, RAN node 210 and AMF 215 are located in the visited PLMN and the UDM/UDR 801 in the home PLMN.

According to the fifth solution of the disclosure, the UE 205 initiates a NAS Deregistration procedure towards the core network (e.g., the AMF 215) in order to clear the UE context in the serving network (e.g., in the current serving SNPN). For this purpose, the UE 205 may indicate to the network (e.g., to the AMF 215) in the Deregistration request message a new deregistration cause, e.g., due to change of SNPN mode of operation which would result in the serving network to clear the network resources (control plane and user plane) for this UE 205.

FIG. 9 shows an exemplary message flow for a procedure 900 for UE-requested SNPN access mode change, according to the fifth solution. The procedure 900 involves the UE 205 and an SNPN 901 comprising the RAN node 210, the AMF 215, and a UDM/UDR 903. Here, the UDM/UDR 903 may be one embodiment of the UDM/UDR 149. The description of FIG. 9 is as follows:

At step 0, the UE 205 is configured to operate in SNPN access mode (i.e., the SNPN access mode is enabled). The UE 205 selects cells and performs SNPN selection (see block 905).

Steps 1 to 3 are according to the existing registration procedure for the SNPN 901. At step 1, the UE 205 performs a RACH procedure and RRC connection establishment (Step 1a; see messaging 910) in order to transmit the NAS Registration Request message (Step 1b; see messaging 915).

At step 2, if the AMF 215 does not have the current UE subscription, the AMF 215 retrieves the UE subscription data from the UDM 903 (see messaging 920).

At step 3, after the AMF 215 determined the UE mobility restrictions, the AMF 215 sends the mobility restriction information to the UE 205 (via NAS registration accept message) and to the RAN node 210 (via N2 NGAP message) (see messaging 925).

At step 4, at some later time, the disabling of the SNPN access mode is triggered internally in the UE 205 (see block 930). This can be done by triggering in the high-layers (e.g., above NAS layer) or by any human or another program API.

At step 5, based on the trigger to disable the SNPN access mode, the NAS layer in the UE 205 initiates the NAS Deregistration procedure. The UE 205 sends to the AMF 215 a NAS message Deregistration Request (5G-GUTI, Deregistration type (e.g., “due to change of the SNPN access mode”, Access Type) (see messaging 935). The UE 205 includes a new parameter (e.g., can be specified as a new Deregistration type) to the AMF 215 to indicate that the Deregistration Request is due to change (e.g., disabling) of the SNPN access mode.

At step 6, the network performs the Deregistration procedure within the core network, e.g., the AMF 215 can initiate the release of the UE context in the associated SMFs, PCFs, etc. At step 6a, the AMF 215 is to deregister the UE 205 from the UDM/UDR 903 (see block 940). In addition, at step 6b the AMF 215 may send a Deregistration Accept message to the UE 205 confirming the successful deregistration (see messaging 945). Note that transmission of the Deregistration Accept message depends on whether the UE 205 indicates “switch off” or not in the Deregistration request message. If “switch off” is not indicated then AMF 215 sends the accept message, otherwise the Deregistration Accept message is not sent. In the depicted embodiment, it is assumed that “switch off” is not indicated by the UE 205. The AMF 215 also releases the N2 association and UE context in the RAN node 210.

At step 7, the UE 205 initiates a PLMN search according to the configuration (e.g., from the USIM) for public network (e.g., PLMNs) (see block 950).

At step 8, the UE 205 performs Registration procedure to the selected PLMN 902 (see messaging 955).

It should be noted that the embodiments of the fifth solution may be also applied in the scenario where the UE 205 is registered with a PLMN 902 and the UE 205 enables the SNPN access mode, i.e., the UE 205 wants to use the services of an SNPN 901. The UE 205 would perform the same procedure as described in FIG. 9, but roles of the SNPN 901 and PLMN 902 are exchanged (i.e., after deciding to activate SNPN access mode, the UE 205 would deregister from the PLMN 902 and register with the SNPN 901).

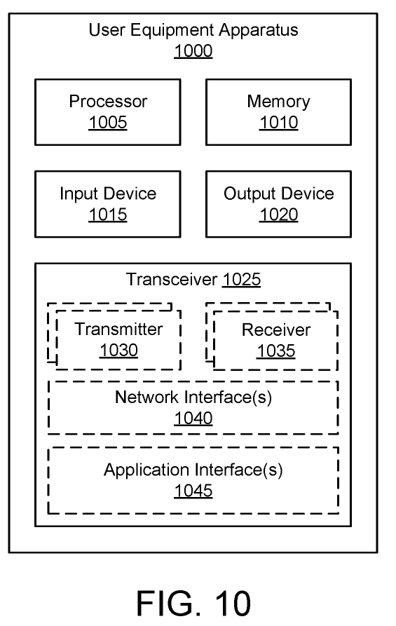

FIG. 10 depicts a user equipment apparatus 1000 that may be used configuring a non-public network, according to embodiments of the disclosure. In various embodiments, the user equipment apparatus 1000 is used to implement one or more of the solutions described above. The user equipment apparatus 1000 may be one embodiment of the remote unit 105, the UE 205, the UE#1 305, and/or the UE#1 605, described above. Furthermore, the user equipment apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the user equipment apparatus 1000 may not include any input device 1015 and/or output device 1020. In various embodiments, the user equipment apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. In some embodiments, the transceiver 1025 communicates with one or more cells (or wireless coverage areas) supported by one or more base units 121. Additionally, the transceiver 1025 may support at least one network interface 1040 and/or application interface 1045. The application interface(s) 1045 may support one or more APIs. The network interface(s) 1040 may support 3GPP reference points, such as Uu, N1, PC5, etc. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the processor 1005 controls the user equipment apparatus 1000 to implement the above described UE behaviors. For example, the processor 1005 may send (e.g., via the transceiver 1025) a first message to a RAN node, the first message containing a first indication of an access mode of the user equipment apparatus 1000. The processor 1005 may also receive (e.g., via the transceiver 1025) a second message specifying at least one measurement configuration from the RAN node. The processor 1005 performs measurement of at least one neighboring cell of the communication network in accordance with the at least one measurement configuration. Via the transceiver 1025, the processor 1005 sends to the RAN node a measurement report containing measurement results and receives a third message instructing the user equipment apparatus 1000 to handover to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the user equipment apparatus 1000, for example information specifying whether a communication device is a type of device for which cell access restrictions need to be applied. In certain embodiments, the restriction indication includes information specifying whether the user equipment apparatus 1000 is a type of device for which cell access restrictions are to be applied. In some embodiments, the at least one measurement configuration includes at least a configuration for performing measurements and a configuration for reporting measurement results.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the processor 1005 further: A) receives (via the transceiver) a trigger that the user equipment apparatus 1000 is to be access-restricted to a set of radio cells for non-public use, B) sends a second indication to the RAN node that indicates the user equipment apparatus 1000 is access-restricted to the set of radio cells for non-public use, and C) receives a third message specifying at least one modified measurement configuration. In such embodiments, performing measurements and sending the measurement report occurs in accordance with the at least one modified measurement configuration. In one embodiment, the second indication is a CAG-only indication. In another embodiment, the second indication is a SNPN access mode indication. In certain embodiments, the at least one modified measurement configuration indicates not to perform measurements of any public radio cell in the communication network.

In various embodiments, the processor 1005 receives (e.g., via the transceiver 1025) a first registration accept message containing mobility restriction information, the mobility restriction information permitting UE-initiated change of a NPN access mode (e.g., CAG-only or SNPN access mode). The processor 1005 later determines to trigger a change of the NPN access mode while operating in a first NPN access mode. Via the transceiver 1025, the processor 1005 sends a registration request message comprising a request to change the NPN access mode and receives a second registration accept message containing a response to the request to change the NPN access mode.

In some embodiments, the second registration accept message contains new mobility restriction information. In certain embodiments, the response to the request to change the NPN access mode is explicitly indicated in the second registration accept message. In other embodiments, the response to the request to change the NPN access mode is implicitly indicated by the new mobility restriction information.

In some embodiments, the first NPN access mode includes an enabled NPN access mode (e.g., enabled CAG-only or SNPN access mode). In certain embodiments, the registration request message is a deregistration request comprising a request to disable the NPN access mode and the second registration accept message is a deregistration accept message that confirms successful deregistration of the UE. In such embodiments, the processor 1005 may initiate a registration procedure with a public mobile network (e.g., a PLMN) in response to receiving the deregistration accept message.

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to configuring measurement reporting in non-public networks. For example, the memory 1010 may store various parameters, configurations, resource assignments, policies, and the like as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the user equipment apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 communicates with one or more network functions of a mobile communication network via one or more access networks. The transceiver 1025 operates under the control of the processor 1005 to transmit messages, data, and other signals and also to receive messages, data, and other signals. For example, the processor 1005 may selectively activate the transceiver 1025 (or portions thereof) at particular times in order to send and receive messages.

The transceiver 1025 includes at least transmitter 1030 and at least one receiver 1035. One or more transmitters 1030 may be used to provide UL communication signals to a base unit 121, such as the UL transmissions described herein. Similarly, one or more receivers 1035 may be used to receive DL communication signals from the base unit 121, as described herein. Although only one transmitter 1030 and one receiver 1035 are illustrated, the user equipment apparatus 1000 may have any suitable number of transmitters 1030 and receivers 1035. Further, the transmitter(s) 1030 and the receiver(s) 1035 may be any suitable type of transmitters and receivers. In one embodiment, the transceiver 1025 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1025, transmitters 1030, and receivers 1035 may be implemented as physically separate components that access a shared hardware resource and/or software resource, such as for example, the network interface 1040.

In various embodiments, one or more transmitters 1030 and/or one or more receivers 1035 may be implemented and/or integrated into a single hardware component, such as a multi-transceiver chip, a system-on-a-chip, an ASIC, or other type of hardware component. In certain embodiments, one or more transmitters 1030 and/or one or more receivers 1035 may be implemented and/or integrated into a multi-chip module. In some embodiments, other components such as the network interface 1040 or other hardware components/circuits may be integrated with any number of transmitters 1030 and/or receivers 1035 into a single chip. In such embodiment, the transmitters 1030 and receivers 1035 may be logically configured as a transceiver 1025 that uses one more common control signals or as modular transmitters 1030 and receivers 1035 implemented in the same hardware chip or in a multi-chip module.

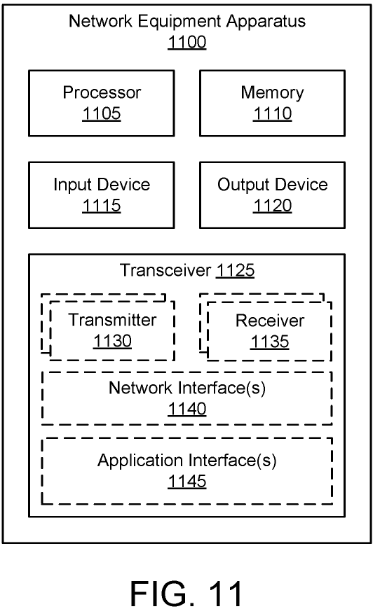

FIG. 11 depicts a network equipment apparatus 1100 that may be used for configuring a non-public network, according to embodiments of the disclosure. In one embodiment, network equipment apparatus 1100 may be one implementation of a RAN node, such as the base unit 121, the RAN node 210, or gNB, described above. In another embodiment, the network equipment apparatus 1100 may be one implementation of an AMF, such as the AMF 143 and/or the AMF 215 described above. Furthermore, the base network equipment apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the network equipment apparatus 1100 may not include any input device 1115 and/or output device 1120. In various embodiments, the network equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. Here, the transceiver 1125 communicates with one or more remote units 105. Additionally, the transceiver 1125 may support at least one network interface 1140 and/or application interface 1145. The application interface(s) 1145 may support one or more APIs. The network interface(s) 1140 may support 3GPP reference points, such as Uu, N1, N2 and N3. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a CPU, a GPU, an auxiliary processing unit, a FPGA, or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the network equipment apparatus 1100 is a RAN node (e.g., gNB) that sends UE configurations and receives measurement reports, as described herein. In such embodiments, the processor 1105 controls the network equipment apparatus 1100 to perform the above described behaviors. For example, the transceiver 1125 may communicate with a UE, where the UE is connected to a non-public radio cell, and receive a first message containing a first indication of an access mode of the UE. Via the transceiver 1125, the processor 1105 sends a second message specifying at least one measurement configuration from the network equipment apparatus 1100 to the UE and receives – from the UE – a measurement report containing measurement results of at least one neighboring radio cell of the communication network. The processor 1105 determines to handover the UE to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the UE, for example information specifying whether a communication device is a type of device for which cell access restrictions need to be applied. In certain embodiments, the restriction indication includes information specifying whether the UE is a type of device for which cell access restrictions are to be applied.

In some embodiments, the first message is received from either the UE or from a core network entity of the communication network (e.g., from the AMF). In some embodiments, the at least one measurement configuration includes at least a configuration for performing measurements and a configuration for reporting measurement results, wherein the UE performs and reports measurement of the at least one neighboring cell of the communication network in accordance with the at least one measurement configuration.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the first message indicates that the UE is permitted to access radio cells for public use and/or radio cells for non-public use. In certain embodiments, the first method further includes receiving a second indication from the UE that indicates that the UE is access-restricted to a set of radio cells for non-public use and transmitting a third message to the UE specifying at least one modified measurement configuration, wherein the UE performs and reports measurement of the at least one neighboring cell of the communication network in accordance with the at least one modified measurement configuration.

In such embodiments, determining to handover the UE to another radio cell includes selecting a neighboring radio cell that belongs to the set of radio cells for non-public use. In one embodiment, the second indication is a CAG-only indication. In another embodiment, the second indication is a SNPN access mode indication. In certain embodiments, the at least one modified measurement configuration indicates not to perform measurements of any public radio cell in the communication network.

In various embodiments, the network equipment apparatus 1100 is an AMF that determines UE mobility restrictions and processes a registration request or de-registration request, as described herein. Here, the processor 1105 controls the network equipment apparatus 1100 to perform the above described AMF behaviors. For example, the processor 1105 may send (e.g., via the transceiver 1125, the network interface 1140 and/or the application interface 1145) a first registration accept message to a UE, the first registration accept message containing mobility restriction information permitting UE-initiated change of a NPN access mode. The processor 1105 may receive (e.g., via the transceiver 1125, the network interface 1140 and/or the application interface 1145) a registration request message from the UE, the registration request message comprising a request to change the NPN access mode of the UE. The processor 1105 may send (e.g., via the transceiver 1125, the network interface 1140 and/or the application interface 1145) a second registration accept message containing a response to the request to change the NPN access mode.

In some embodiments, the processor 1105 further determines to accept the request to change the NPN access mode. In certain embodiments, the second registration accept message contains new mobility restriction information. In one embodiment, the response accepting the request to change the NPN access mode is explicitly indicated in the second registration accept message. In another embodiment, the response accepting the request to change the NPN access mode is implicitly indicated by the new mobility restriction information.

In certain embodiments, first NPN access mode includes an enabled NPN access mode (e.g., enabled CAG-only or SNPN access mode). In such embodiments, the registration request message may be a deregistration request comprising a request to disable the NPN access mode and the second registration accept message may be a deregistration accept message that confirms successful deregistration of the UE.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to configuring measurement reporting in non-public networks. For example, the memory 1110 may store parameters, configurations, resource assignments, policies, and the like, as described above. In certain embodiments, the memory 1110 also stores program code and related data, such as an operating system or other controller algorithms operating on the remote unit 115.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, an LCD display, an LED display, an OLED display, a projector, or similar display device capable of outputting images, text, or the like to a user. As another, non-limiting, example, the output device 1120 may include a wearable display separate from, but communicatively coupled to, the rest of the network equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 includes at least transmitter 1130 and at least one receiver 1135. One or more transmitters 1130 may be used to communicate with the UE, as described herein. Similarly, one or more receivers 1135 may be used to communicate with network functions in the PLMN and/or RAN, as described herein. Although only one transmitter 1130 and one receiver 1135 are illustrated, the network equipment apparatus 1100 may have any suitable number of transmitters 1130 and receivers 1135. Further, the transmitter(s) 1130 and the receiver(s) 1135 may be any suitable type of transmitters and receivers.

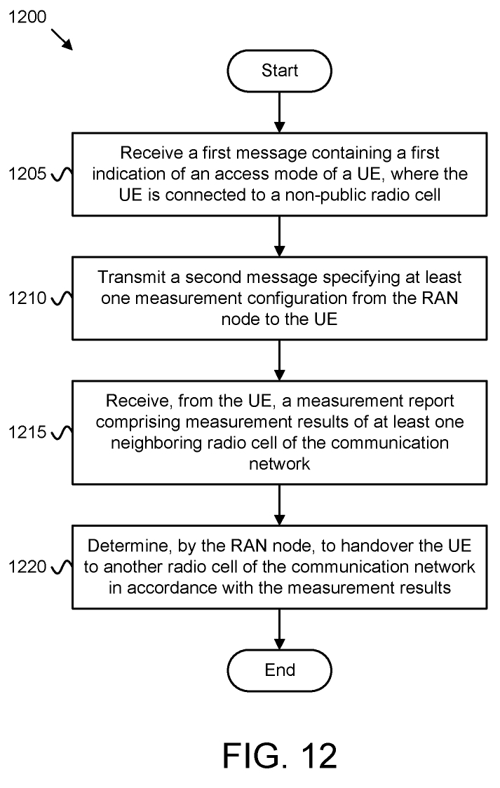

FIG. 12 depicts one embodiment of a method 1200 for configuring measurement reporting in non-public networks, according to embodiments of the disclosure. In various embodiments, the method 1200 is performed by a RAN node, such as the base unit 121, the RAN node 210, a gNB, and/or the network equipment apparatus 1100, described above. In some embodiments, the method 1200 is performed by a processor, such as a microcontroller, a microprocessor, a CPU, a GPU, an auxiliary processing unit, a FPGA, or the like.

The method 1200 begins and receives 1205 a first message containing a first indication of an access mode of a UE, where the UE is connected to a non-public radio cell. The method 1200 includes transmitting 1210 a second message specifying at least one measurement configuration from the RAN node to the UE. The method 1200 includes receiving 1215, from the UE, a measurement report containing the measurement results of at least one neighboring radio cell of the communication network. The method 1200 includes determining 1220, by the RAN node, to handover the UE to another radio cell of the communication network in accordance with the measurement results. The method 1200 ends.

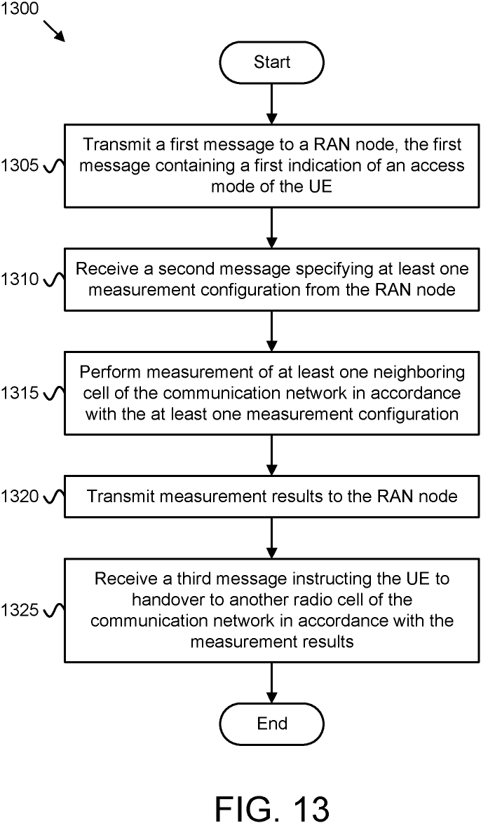

FIG. 13 depicts one embodiment of a method 1300 for configuring measurement reporting in non-public networks, according to embodiments of the disclosure. In various embodiments, the method 1300 is performed by a UE, such as the remote unit 105, the UE 205, the UE#1 305, the UE#1 605, and/or the user equipment apparatus 1000, described above. In some embodiments, the method 1300 is performed by a processor, such as a microcontroller, a microprocessor, a CPU, a GPU, an auxiliary processing unit, a FPGA, or the like.

The method 1300 begins and transmits 1305 a first message to a RAN node, the first message containing a first indication of an access mode of the UE. The method 1300 includes receiving 1310 a second message specifying at least one measurement configuration from the RAN node. The method 1300 includes performing 1315 measurement of at least one neighboring cell of the communication network in accordance with the at least one measurement configuration. The method 1300 includes transmitting 1320 to the RAN node a measurement report containing measurement results. The method 1300 includes receiving 1325 a third message instructing the UE to handover to another radio cell of the communication network in accordance with the measurement results. The method 1300 ends.

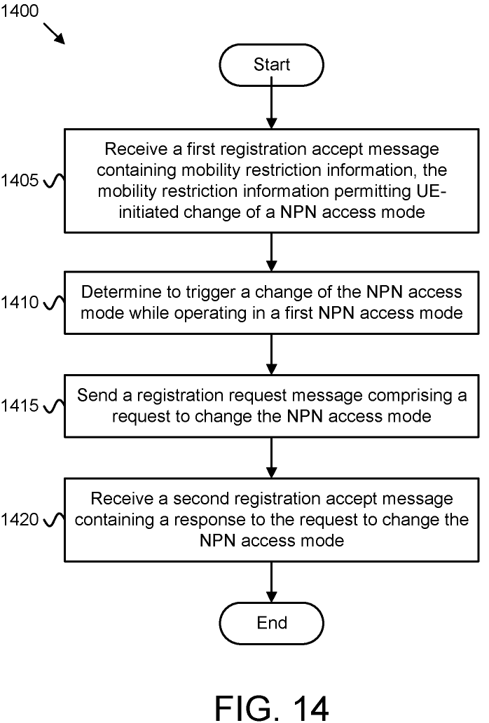

FIG. 14 depicts one embodiment of a method 1400 for configuring measurement reporting in non-public networks, according to embodiments of the disclosure. In various embodiments, the method 1400 is performed by a UE, such as the remote unit 105, the UE 205, the UE#1 305, the UE#1 605, and/or the user equipment apparatus 1000, described above. In some embodiments, the method 1400 is performed by a processor, such as a microcontroller, a microprocessor, a CPU, a GPU, an auxiliary processing unit, a FPGA, or the like.

The method 1400 begins and receives 1405 a first registration accept message containing mobility restriction information, the mobility restriction information permitting UE-initiated change of a NPN access mode. The method 1400 includes determining 1410, by the UE, to trigger a change of the NPN access mode while operating in a first NPN access mode. The method 1400 includes sending 1415 a registration request message comprising a request to change the NPN access mode. The method 1400 includes receiving 1420 a second registration accept message containing a response to the request to change the NPN access mode. The method 1400 ends.

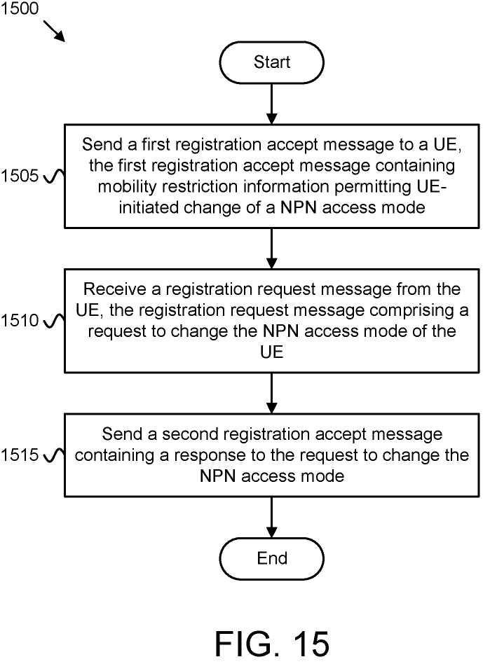

FIG. 15 depicts one embodiment of a method 1500 for configuring measurement reporting in non-public networks, according to embodiments of the disclosure. In various embodiments, the method 1500 is performed by an AMF, such as the AMF 143, the AMF 215 and/or the network equipment apparatus 1100, described above. In some embodiments, the method 1500 is performed by a processor, such as a microcontroller, a microprocessor, a CPU, a GPU, an auxiliary processing unit, a FPGA, or the like.

The method 1500 begins and sends 1505 a first registration accept message to a UE, the first registration accept message containing mobility restriction information permitting UE-initiated change of a NPN access mode. The method 1500 includes receiving 1510 a registration request message from the UE, the registration request message comprising a request to change the NPN access mode of the UE. The method 1500 includes sending 1515 a second registration accept message containing a response to the request to change the NPN access mode. The method 1500 ends.

Disclosed herein is a first apparatus for configuring measurement reporting in non-public networks, according to embodiments of the disclosure. The first apparatus may be implemented by a RAN node in a communication network, such as the base unit 121, the RAN node 210, a gNB, and/or the network equipment apparatus 1100, described above. The first apparatus includes a transceiver that communicates with a UE, where the UE is connected to a non-public radio cell. The first apparatus includes a processor that – via the transceiver – receives a first message containing a first indication of an access mode of the UE and sends a second message specifying at least one measurement configuration from the RAN node to the UE. The processor receives – from the UE and via the transceiver – a measurement report containing measurement results of at least one neighboring radio cell of the communication network and determines to handover the UE to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the UE, for example information specifying whether a communication device is a type of device for which cell access restrictions need to be applied. In certain embodiments, the restriction indication includes information specifying whether the UE is a type of device for which cell access restrictions are to be applied.

In some embodiments, the first message is received from either the UE or from a core network entity of the communication network (e.g., from the AMF). In some embodiments, the at least one measurement configuration includes at least a configuration for performing measurements and a configuration for reporting measurement results. In such embodiments, the UE performs and reports measurement of the at least one neighboring cell of the communication network in accordance with the at least one measurement configuration.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the first message indicates that the UE is permitted to access radio cells for public use and/or radio cells for non-public use. In certain embodiments, the first method further includes receiving a second indication from the UE that indicates that the UE is access-restricted to a set of radio cells for non-public use and transmitting a third message to the UE specifying at least one modified measurement configuration. In such embodiments, the UE performs and reports measurement of the at least one neighboring cell of the communication network in accordance with the at least one modified measurement configuration.

In such embodiments, determining to handover the UE to another radio cell includes selecting a neighboring radio cell that belongs to the set of radio cells for non-public use. In one embodiment, the second indication is a CAG-only indication. In another embodiment, the second indication is a SNPN access mode indication. In certain embodiments, the at least one modified measurement configuration indicates not to perform measurements of any public radio cell in the communication network.

Disclosed herein is a first method for configuring measurement reporting in non-public networks, according to embodiments of the disclosure. The first method may be performed by a RAN node in a communication network, such as the base unit 121, the RAN node 210, a gNB, and/or the network equipment apparatus 1100, described above. The first method includes receiving a first message containing a first indication of an access mode of a UE, where the UE is connected to a non-public radio cell, and transmitting a second message specifying at least one measurement configuration from the RAN node to the UE. The first method includes receiving, from the UE, a measurement report containing the measurement results of at least one neighboring radio cell of the communication network and determining, by the RAN node, to handover the UE to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the UE, for example information specifying whether a communication device is a type of device for which cell access restrictions need to be applied. In certain embodiments, the restriction indication includes information specifying whether the UE is a type of device for which cell access restrictions are to be applied.

In some embodiments, the first message is received from either the UE or from a core network entity of the communication network (e.g., from the AMF). In some embodiments, the at least one measurement configuration includes at least a configuration for performing measurements and a configuration for reporting measurement results. In such embodiments, the UE performs and reports measurement of the at least one neighboring cell of the communication network in accordance with the at least one measurement configuration.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the first message indicates that the UE is permitted to access radio cells for public use and/or radio cells for non-public use. In certain embodiments, the first method further includes receiving a second indication from the UE that indicates that the UE is access-restricted to a set of radio cells for non-public use and transmitting a third message to the UE specifying at least one modified measurement configuration. In such embodiments, the UE performs and reports measurement of the at least one neighboring cell of the communication network in accordance with the at least one modified measurement configuration.

In such embodiments, determining to handover the UE to another radio cell includes selecting a neighboring radio cell that belongs to the set of radio cells for non-public use. In one embodiment, the second indication is a CAG-only indication. In another embodiment, the second indication is a SNPN access mode indication. In certain embodiments, the at least one modified measurement configuration indicates not to perform measurements of any public radio cell in the communication network.

Disclosed herein is a second apparatus for configuring measurement reporting in non-public networks, according to embodiments of the disclosure. The second apparatus may be implemented by a UE connected to a non-public radio cell in a communication network, such as the remote unit 105, the UE 205, the UE#1 305, the UE#1 605, and/or the user equipment apparatus 1000, described above. The second apparatus includes a transceiver that communicates with a non-public radio cell in a communication network. The second apparatus includes a processor that sends (via the transceiver) a first message to a RAN node, the first message containing a first indication of an access mode of the UE and receives (via the transceiver) a second message specifying at least one measurement configuration from the RAN node. The processor performs measurement of at least one neighboring cell of the communication network in accordance with the at least one measurement configuration. Via the transceiver, the processor sends to the RAN node a measurement report containing measurement results and receives a third message instructing the UE to handover to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the UE, for example information specifying whether a communication device is a type of device for which cell access restrictions need to be applied. In certain embodiments, the restriction indication includes information specifying whether the UE is a type of device for which cell access restrictions are to be applied. In some embodiments, the at least one measurement configuration includes at least a configuration for performing measurements and a configuration for reporting measurement results.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the processor further: A) receives (via the transceiver) a trigger that the UE is to be access-restricted to a set of radio cells for non-public use, B) sends a second indication to the RAN node that indicates the UE is access-restricted to the set of radio cells for non-public use, and C) receives a third message specifying at least one modified measurement configuration. In such embodiments, performing measurements and sending the measurement report occurs in accordance with the at least one modified measurement configuration. In one embodiment, the second indication is a CAG-only indication. In another embodiment, the second indication is a SNPN access mode indication. In certain embodiments, the at least one modified measurement configuration indicates not to perform measurements of any public radio cell in the communication network.

Disclosed herein is a second method for configuring measurement reporting in non-public networks, according to embodiments of the disclosure. The second method may be performed by a UE connected to a non-public radio cell in a communication network, such as the remote unit 105, the UE 205, the UE#1 305, the UE#1 605, and/or the user equipment apparatus 1000, described above. The second method includes transmitting a first message to a RAN node, the first message containing a first indication of an access mode of the UE and receiving a second message specifying at least one measurement configuration from the RAN node. The second method includes performing measurement of at least one neighboring cell of the communication network in accordance with the at least one measurement configuration and transmitting to the RAN node a measurement report containing measurement results. The second method includes receiving a third message instructing the UE to handover to another radio cell of the communication network in accordance with the measurement results.

The first indication includes information specifying whether a communication device is allowed to access the communication network for public and/or non-public use. In certain embodiments, the first indication of the access mode includes information specifying a communication network access type for a UE, the communication network access type selected from the group consisting of: A) public use only, B) non-public use only, and C) both public and non-public use.

In some embodiments, the first message includes a restriction indication for the UE, for example information specifying whether a communication device is a type of device for which cell access restrictions need to be applied. In certain embodiments, the restriction indication includes information specifying whether the UE is a type of device for which cell access restrictions are to be applied. In some embodiments, the at least one measurement configuration includes at least a configuration for performing measurements and a configuration for reporting measurement results.

In some embodiments, the second message is transmitted using Access Stratum protocols, where the second message includes one or more of the following parameters: A) a type of cell to measure; B) an identity of one or more communication networks for which measurements are to be reported; C) a member status of the one or more communication networks for non-public use; D) an identity of one or more access groups associated with cells of the one or more communication networks for non-public use; and/or E) an indication of one or more cell access restrictions for communication devices (i.e. UEs) for which cell access restrictions are to be applied. In certain embodiments, the type of cell to measure indicates one of: A) both public cells and private cells with SNPN; B) both public cells and private cells with CAG; C) only public cells; D) private cells with SNPN and/or CAG; E) only private cells with SNPN; and F) only private cells with CAG.

In certain embodiments, the measurement report includes one or more of the following parameters: A) an identity of one or more communication networks for which measurements are being reported (e.g., PLMN-Identity list for SNPN / PNI-NPN, as described above); B) a member status of the one or more communication networks for non-public use (e.g., Member status per SNPN / PNI-NPN cell, as described above); C) an identity of one or more access groups associated with cells of the one or more communication networks for non-public use (e.g., CAG identities per PNI-NPN cell with CAG, as described above); and/or D) an indication of one or more cell access restrictions for communication devices (i.e. UEs) for which cell access restrictions are to be applied (e.g., Cell access restrictions for new UE types, as described above).

In some embodiments, the second method includes receiving a trigger that the UE is to be access-restricted to a set of radio cells for non-public use, transmitting a second indication to the RAN node that indicates the UE is access-restricted to the set of radio cells for non-public use, and receiving a third message specifying at least one modified measurement configuration. In such embodiments, performing measurements and transmitting the measurement report occurs in accordance with the at least one modified measurement configuration. In one embodiment, the second indication is a CAG-only indication. In another embodiment, the second indication is a SNPN access mode indication. In certain embodiments, the at least one modified measurement configuration indicates not to perform measurements of any public radio cell in the communication network.

Disclosed herein is a third apparatus for configuring measurement reporting in non-public networks, according to embodiments of the disclosure. The third apparatus may be implemented by a UE, such as the remote unit 105, the UE 205, the UE#1 305, the UE#1 605, and/or the user equipment apparatus 1000, described above. The third apparatus includes a transceiver that receives a first registration accept message containing mobility restriction information, the mobility restriction information permitting UE-initiated change of a non-public network (“NPN”) access mode. The third method includes a processor that determines to trigger a change of the NPN access mode while operating in a first NPN access mode. Via the transceiver, the processor sends a registration request message comprising a request to change the NPN access mode and receives a second registration accept message containing a response to the request to change the NPN access mode.

In some embodiments, the second registration accept message contains new mobility restriction information. In certain embodiments, the response to the request to change the NPN access mode is explicitly indicated in the second registration accept message. In other embodiments, the response to the request to change the NPN access mode is implicitly indicated by the new mobility restriction information.

In some embodiments, the first NPN access mode includes an enabled NPN access mode (e.g., CAG-only access mode or SNPN access mode). In certain embodiments, the registration request message is a deregistration request comprising a request to disable the first access mode and the second registration accept message is a deregistration accept message that confirms successful deregistration of the UE. In such embodiments, the processor may initiate a registration procedure with a public mobile network (e.g., a PLMN) in response to receiving the deregistration accept message.

Disclosed herein is a third method for configuring measurement reporting in non-public networks, according to embodiments of the disclosure. The third method may be performed by a UE, such as the remote unit 105, the UE 205, the UE#1 305, the UE#1 605, and/or the user equipment apparatus 1000, described above. The third method includes receiving a first registration accept message containing mobility restriction information, the mobility restriction information permitting UE-initiated change of a NPN access mode. The third method includes determining, by the UE, to trigger a change of the NPN access mode while operating in a first NPN access mode and sending a registration request message comprising a request to change the NPN access mode. The third method includes receiving a second registration accept message containing a response to the request to change the NPN access mode.

In some embodiments, the second registration accept message contains new mobility restriction information. In certain embodiments, the response to the request to change the NPN access mode is explicitly indicated in the second registration accept message. In other embodiments, the response to the request to change the NPN access mode is implicitly indicated by the new mobility restriction information.

In some embodiments, the first NPN access mode includes an enabled NPN access mode (e.g., CAG-only access mode or SNPN access mode). In certain embodiments, the registration request message is a deregistration request comprising a request to disable the first access mode and the second registration accept message is a deregistration accept message that confirms successful deregistration of the UE. In such embodiments, the third method includes initiating a registration procedure with a public mobile network (e.g., a PLMN) in response to receiving the deregistration accept message.

Disclosed herein is a fourth apparatus for configuring measurement reporting in non-public networks, according to embodiments of the disclosure. The fourth apparatus may be implemented by an AMF, such as the AMF 143, the AMF 215, and/or the network equipment apparatus 1100, described above. The fourth apparatus includes a network interface that sends a first registration accept message to a UE, the first registration accept message containing mobility restriction information permitting UE-initiated change of a non-public network (“NPN”) access mode. The fourth apparatus includes a processor that receives (e.g., via the network interface) a registration request message from the UE, the registration request message comprising a request to change the NPN access mode of the UE. The processor sends (e.g., via the network interface) a second registration accept message containing a response to the request to change the NPN access mode.

In some embodiments, the processor further determines to accept the request to change the NPN access mode. In certain embodiments, the second registration accept message contains new mobility restriction information. In one embodiment, the response accepting the request to change the NPN access mode is explicitly indicated in the second registration accept message. In another embodiment, the response accepting the request to change the NPN access mode is implicitly indicated by the new mobility restriction information.

In certain embodiments, first NPN access mode includes an enabled NPN access mode (e.g., CAG-only access mode or SNPN access mode). In such embodiments, the registration request message may be a deregistration request comprising a request to disable the first access mode and the second registration accept message may be a deregistration accept message that confirms successful deregistration of the UE.

Disclosed herein is a fourth method for configuring measurement reporting in non-public networks, according to embodiments of the disclosure. The fourth method may be performed by an AMF, such as the AMF 143, the AMF 215, and/or the network equipment apparatus 1100, described above. The fourth method includes sending a first registration accept message to a UE, the first registration accept message containing mobility restriction information permitting UE-initiated change of a NPN access mode. The fourth method includes receiving a registration request message from the UE, the registration request message comprising a request to change the NPN access mode of the UE and sending a second registration accept message containing a response to the request to change the NPN access mode.

In some embodiments, the fourth method includes determining, by the AMF, to accept the request to change the NPN access mode. In certain embodiments, the second registration accept message contains new mobility restriction information. In one embodiment, the response accepting the request to change the NPN access mode is explicitly indicated in the second registration accept message. In another embodiment, the response accepting the request to change the NPN access mode is implicitly indicated by the new mobility restriction information.

In certain embodiments, first NPN access mode includes an enabled NPN access mode (e.g., CAG-only access mode or SNPN access mode). In such embodiments, the registration request message may be a deregistration request comprising a request to disable the first access mode and the second registration accept message may be a deregistration accept message that confirms successful deregistration of the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a radio access network (“RAN”) node in a communication network, the method comprising:
receiving a first message from a user equipment device (“UE”), the first message containing a first indication of an access mode of the UE , wherein the UE is connected to a non-public radio cell;
transmitting a second message specifying at least one measurement configuration to the UE according to the first message;
receiving, from the UE, a measurement report comprising measurement results of at least one neighboring radio cell of the communication network;
determining, by the RAN node, to handover the UE to another radio cell of the communication network in accordance with the measurement results; and
transmitting a third message to the UE instructing the UE to handover to another radio cell of the communication network in accordance with the measurement results.

2. The method of claim 1, wherein the first indication of the access mode comprises information specifying a communication network access type for a UE, the communication network access type selected from the group consisting of: public use only, non-public use only, and both public and non-public use.

3. The method of claim 1, wherein the first message comprises a restriction indication for the UE, wherein the restriction indication comprises information specifying whether the UE is a type of device for which cell access restrictions are to be applied.

4. (canceled)

5. The method of claim 1, wherein the at least one measurement configuration comprises at least a configuration for performing measurements and a configuration for reporting measurement results .

6. The method of claim 1, wherein the second message is transmitted using Access Stratum protocols, wherein the second message comprises one or more of the following parameters:
a type of cell to measure;
an identity of one or more communication networks for which measurements are to be reported;
a member status of the one or more communication networks for non-public use;
an identity of one or more access groups associated with cells of the one or more communication networks for non-public use; and
an indication of one or more cell access restrictions for communication devices for which cell access restrictions are to be applied.

7. The method of claim 1, wherein the measurement report comprises one or more of the following parameters:
an identity of one or more communication networks for which measurements are being reported;
a member status of the one or more communication networks for non-public use;
an identity of one or more access groups associated with cells of the one or more communication networks for non-public use; and
an indication of one or more cell access restrictions for communication devices for which cell access restrictions are to be applied.

8. The method of claim 1, wherein the first message indicates that the UE is permitted to access radio cells for public use and/or radio cells for non-public use, the method further comprising:
receiving a second indication from the UE that indicates that the UE is access-restricted to a set of radio cells for non-public use; and
transmitting a fourth message to the UE specifying at least one modified measurement configuration, wherein the UE performs and reports measurement of the at least one neighboring cell of the communication network in accordance with the at least one modified measurement configuration,
wherein determining to handover the UE to another radio cell comprises selecting a neighboring radio cell that belongs to the set of radio cells.

9. The method of claim 8, wherein the at least one modified measurement configuration indicates not to perform measurements of any public radio cell in the communication network.

10. A radio access network (“RAN”) apparatus in a communication network comprising:
a transceiver that communicates with a user equipment device (“UE”), wherein the UE is connected to a non-public radio cell; and
a processor that:
receives a first message from the UE containing a first indication of an access mode of the UE;
sends a second message specifying at least one measurement configuration to the UE according to the first message;
receives, from the UE, a measurement report comprising measurement results of at least one neighboring radio cell of the communication network;
determines to handover the UE to another radio cell of the communication network in accordance with the measurement results; and
sends a third message to the UE instructing the UE to handover to another radio cell of the communication network in accordance with the measurement results.

11. A method performed by a user equipment device (“UE”) connected to a non-public radio cell in a communication network, the method comprising:
transmitting a first message to a radio access network (“RAN”) node, the first message containing a first indication of an access mode of the UE;
receiving a second message specifying at least one measurement configuration from the RAN node according to the first message;
performing measurement of at least one neighboring cell of the communication network in accordance with the at least one measurement configuration;
transmitting measurement results to the RAN node; and
receiving a third message from the RAN node instructing the UE to handover to another radio cell of the communication network in accordance with the measurement results.

12. The method of claim 11, wherein the first indication of the access mode comprises information specifying a communication network access type for a UE, the communication network access type selected from the group consisting of: public use only, non-public use only, and both public and non-public use.

13. The method of claim 11, wherein the first message comprises a restriction indication for the UE, wherein the restriction indication comprises information specifying whether the UE is a type of device for which cell access restrictions are to be applied.

14. The method of claim 11, wherein the at least one measurement configuration comprises at least a configuration for performing measurements and a configuration for reporting measurement results.

15. The method of claim 11, wherein the second message comprises one or more of the following parameters:
a type of cell to measure;
an identity of one or more communication networks for which measurements are to be reported;
a member status of the one or more communication networks for non-public use;
an identity of one or more access groups associated with cells of the one or more communication networks for non-public use; and
an indication of one or more cell access restrictions for communication devices for which cell access restrictions are to be applied.

16. The method of claim 11, further comprising:
receiving a trigger that the UE is to be access-restricted to a set of radio cells for non-public use,
transmitting a second indication to the RAN node that indicates the UE is access-restricted to the set of radio cells for non-public use; and
receiving a fourth message specifying at least one modified measurement configuration, wherein performing measurements and transmitting measurement results occurs in accordance with the at least one modified measurement configuration.

17. The method of claim 16, wherein the at least one modified measurement configuration indicates not to perform measurements of any public radio cell in the communication network.

18. A user equipment (“UE”) apparatus comprising:
a transceiver that communicates with a non-public radio cell in a communication network; and
a processor that:
sends a first message to a radio access network (“RAN”) node, the first message containing a first indication of an access mode of the UE;
receives a second message specifying at least one measurement configuration from the RAN node according to the first message;
performs measurement of at least one neighboring cell of the communication network in accordance with the at least one measurement configuration;
sends measurement results to the RAN node; and
receives a third message from the RAN node instructing the UE to handover to another radio cell of the communication network in accordance with the measurement results.

19. (canceled)

20. (canceled)
